(19) United States
(12) Patent Application Publication
(10) Pub. No.: US 2024/0337296 A1
(43) Pub. Date: Oct. 10, 2024

(54) THE BRAKE ACTUATING DEVICE AND METHOD FOR PRODUCING SAID DEVICE

(71) Applicant: Robert Bosch GmbH, Stuttgart (DE)

(72) Inventors: Andreas Weh, Sulzberg (DE); Martin Hagspiel, Rettenberg (DE)

(21) Appl. No.: 18/435,839

(22) Filed: Feb. 7, 2024

(30) Foreign Application Priority Data
Apr. 6, 2023 (DE) 10 2023 203 202.3

(51) Int. Cl. F16D 65/18; F16D 65/54; F16D 121/02

(52) U.S. Cl. CPC F16D 65/18; F16D 65/54; F16D 2121/02

(57) ABSTRACT

In a brake actuating device, in particular a vehicle brake system. The brake actuating device includes a housing, in which a piston seat is disposed which is surrounded by a wall and comprises a receiving axis along which a piston to be coupled to a piston rod can be accommodated in the piston seat in an axially displaceable manner. At its end region which is directed toward the piston rod, the piston seat includes a guide section in which a guide element for guiding the piston rests radially against the wall. The guide element is axially held in position by means of a radial groove disposed in the guide section.

### CROSS REFERENCE

The present application claims the benefit under 35 U.S.C. § 119 of German Patent Application No. DE 10 2023 203 202.3 filed on Apr. 6, 2023, which is expressly incorporated herein by reference in its entirety.

### BACKGROUND INFORMATION

The present invention relates to a brake actuating device, in particular a vehicle brake system. According to an example embodiment of the present invention, the brake actuating device includes a housing, in which a piston seat is disposed which is surrounded by a wall and comprises a receiving axis along which a piston to be coupled to a piston rod can be accommodated in the piston seat in an axially displaceable manner, wherein, at its end region which is directed toward the piston rod, the piston seat comprises a guide section in which a guide element for guiding the piston rests radially against the wall. The present invention also relates to a method for producing such a brake actuating device.

Conventional brake actuating devices are associated with hydraulic vehicle brake systems. This involves using a hydraulic unit and a pressure medium guided in said unit to provide regulated brake pressure in brake circuits. To generate the brake pressure or to detect a braking request, a master brake cylinder which can be actuated by means of a pedal or a lever is often provided. Traditionally, when a pedal or lever is actuated by a driver, thereby exerted mechanical force is converted to a hydraulic force by increasing the pressure on the pressure medium; this hydraulic force then acts as a braking force on associated wheel brakes. In newer brake systems, the master brake cylinder is used to generate such brake pressure only in the event of a fault and is provided to detect a braking request in normal operation with the aid of corresponding sensor system. Depending on the detected braking request, the actual brake pressure is generated on the wheel brakes with pressure medium from an electrically controllable pressure build-up device as an external source of force.

For actuation, conventional master brake cylinders or pressure-generating cylinders generally comprise a brake actuating device which is usually designed with a block-shaped housing. A cylindrical piston seat with a receiving axis, in which the one cylinder and a piston guided therein are disposed, is formed in the housing block. The piston is coupled to an input rod which is connected to the pedal in such a way that the piston can be moved axially into the piston seat when the pedal is actuated. As it undergoes its translational movement, the piston is guided along the receiving axis by a guide element which is disposed radially around the piston. The guide element serves primarily to provide support against transverse forces that occur during operation and are mostly generated when the pedal is actuated. The transverse forces produce wear-promoting forces that act on the piston and the guide element. The most typically used guide elements are guide rings, which are made of anodized aluminum and are caulked to the housing to secure them to the mouth of the piston seat. Alternatively, the cylinder or the piston seat is anodized in a guide section on its surface which faces the piston in order to prevent wear.

### SUMMARY

According to the present invention, a brake actuating device, in particular a vehicle brake system, is provided. According to an example embodiment of the present invention, the brake actuating device including comprising a housing is created, in which a piston seat is disposed which is surrounded by a wall and comprises a receiving axis along which a piston to be coupled to a piston rod can be accommodated in the piston seat in an axially displaceable manner, wherein, at its end region which is directed toward the piston rod, the piston seat comprises a guide section in which a guide element for guiding the piston rests radially against the wall. The guide element is axially held in position by means of a radial groove disposed in the guide section. The guide element is in particular held axially solely by means of the in relation to the receiving axis radial groove and is thus secured against axial displacement along the receiving axis.

During operation, the guide element guides the piston in its axial movement. For this purpose, the guide element is preferably only partly disposed in the groove and partly projects slightly into the piston seat. Thus a correspondingly small guide gap for the piston is created. The radial groove is furthermore preferably radially circumferential.

Such a groove or guide groove provides a recess in the wall which is intended to surround the piston. The recess comprises two substantially radially extending groove cheeks, between which there is a substantially axially extending groove base. At least one of the two groove cheeks provides axial support for the guide element as a shoulder. Both groove cheeks preferably form an axial support in both axial directions. The guide element is thus stable and particularly easily held in a form-locking manner in axial direction when at least partly accommodated in the groove. The guide element is secured against axial displacement in both directions as the piston is being moved back and forth during operation.

Such axial fixation of the guide element according to the present invention by means of the groove holds the guide element axially in position without caulking. Inserting the piston into the piston seat radially inside the guide element creates a form fit, which holds the guide element overall in position. The guide element is then radially disposed between the wall and the piston. There is no need for conventional caulking of a material of the housing at a mouth of the piston seat to the guide element. Caulking is a process step that can only be carried out after the guide element, the piston and associated other elements are assembled in the piston seat. Caulking is therefore an inconvenient and time-consuming process step in the time sequence of a manufacturing process. The groove according to the present invention eliminates this process step. Considerable costs can be saved.

According to an example embodiment of the present invention, the groove has preferably already been created during manufacturing and assembly of the housing, and in particular during the production of the piston seat. The piston seat and the groove can preferably be produced in just one step using a machining process. The groove is therefore very efficient, easy and cost-effective to produce.

According to an example embodiment of the present invention, the guide element is furthermore preferably designed as a guide ring or guide bushing, which is radially completely accommodated in the groove and is thus designed to radially completely surround the piston. This ensures a particularly even transmission of force.

According to an example embodiment of the present invention, the piston is designed as an actuator piston and, in the assembled state, is preferably connected to a pedal which is coupled to a piston rod. When the pedal is actuated, transverse forces are transmitted to the piston rod or the input rod, which is moved on a portion of a circular path at its end disposed on the pedal. Thus, an actuating force of the piston rod not only acts axially on the piston but also on the piston with a transverse force component, which pushes the piston against the piston seat. Such transverse forces are transferred from the piston to the guide element. The guide element is held axially in the groove and disposed in the guide section on the end region of the piston seat which faces toward the piston rod. The transmitted transverse forces are thus particularly efficiently received by the guide element close to their point of transmission which acts on the piston and transmitted to the housing. The guide element is also subjected to axial forces that occur when the piston is moved axially and to shear forces caused by friction and guides the piston in radial direction.

According to an example embodiment of the present invention, at least for insertion into the guide section, the guide element advantageously comprises a radially directed pretension with which the guide element is forced into the groove or spread. With such a pretension, the guide element snaps or clicks into the groove provided for this purpose particularly easily in terms of production when it is inserted into the guide section and is held there at least axially. The guide element is preferably designed with a radially directed pretension that still has a certain radially directed tension even after it has been inserted into the groove. The guide element is thus held radially in the groove in a captive and easy-to-handle manner, even without a piston.

According to an example embodiment of the present invention, the guide element is moreover advantageously designed as a radially open guide ring comprising an opening and two oppositely disposed ring ends. The opening extends axially continuously from a radial inner surface to a radial outer surface and from an inner end face to an outer end face of the guide ring. The guide ring preferably comprises a lateral surface having a certain axial extent and is thus designed as a radially open guide bushing to transmit force well. The opening provides a particularly flexibly deformable configuration of the guide element. Such deformability is in particular advantageous for creating the radial pretension that is preferred for insertion into the groove. For this purpose, the opening is preferably slot-shaped and is in particular Z-shaped, V-shaped, W-shaped or helical. The opening particularly preferably extends obliquely to the longitudinal axis of the guide element. This makes it easier to twist in the lateral surface in a conical manner. At least for insertion into the guide section, the two ring ends are advantageously partly overlaid at the opening, wherein the radial inner surface is partly laid over the radial outer surface. The lateral surface is thus twisted in to a certain extent at its opening, so that the radial pretension or shrink with which the guide element is forced into the groove is achieved. When the twisted-in lateral surface is pushed axially into the guide section, when it reaches the groove, the lateral surface snaps open and into its ring shape and into the groove.

Advantageously according to an example embodiment of the present invention, the guide element comprises a radial outer surface with a radial elevation or shape, wherein the radial elevation is designed to engage in the groove and engages in the groove after insertion of the guide element. The guide element is thus not completely accommodated in the groove, but only partly at its radial elevation. The guide element projects radially in the direction of the piston seat while at the same time resting axially in the groove. This improves radial abutment against the piston and support of the piston in radial direction. The radial elevation in the groove secures the guide element in a form-locking manner and holds it stationary in axial position. The elevation is preferably radially circumferential or designed as an outer ring.

According to an example embodiment of the present invention, the radial elevation advantageously comprises a chamfer, which is in particular tapered. The chamfer is preferably directed toward the inner end face and is designed such that the elevation narrows or tapers in the direction from the mouth into the piston seat. This makes it easier to insert the guide element into the piston seat and snap the elevation into the groove. For this purpose, the radial elevation with the chamfer is preferably designed as a stepped shoulder. In particular, a guide element which has no radial elevation on its outer surface and is preferably accommodated in the groove with its entire axial extent, is also designed on its inner end face with a chamfer that tapers into the piston seat.

According to an example embodiment of the present invention, the radial elevation is furthermore advantageously disposed axially in the center of the outer surface. This achieves an evenly force-transmitting, at least largely symmetrical design of the guide element with the outer circumferential ring. For this purpose, the chamfer which is directed toward the inner end face is preferably also configured on the radial elevation. The guide element is particularly preferably designed to be overall symmetrical in a longitudinal section along the receiving axis. The guide element therefore does not have to be specially aligned for assembly. Assembly is made easier and assembly errors are avoided.

Alternatively, according to an example embodiment of the present invention, the radial elevation is advantageously disposed axially off-centered on the outer surface, as a result of which the guide element is asymmetrical in its longitudinal section along the receiving axis. The guide element can thus particularly be assembled as needed. The radial elevation is preferably disposed closer to the inner end face than to the outer end face, and particularly preferably on the inner end face. The guide element is thus held in the groove at its axially inner region, and can project out of the guide region and extend out of the housing with its axially outer region as needed.

The guide element preferably extends beyond the housing. This reduces pressure on the guide element outside the housing caused by the transverse forces acting on the piston. The transverse forces are received outside the housing already by the increased elasticity of the guide element that is effective there, which improves the guidance of the piston.

According to an example embodiment of the present invention, the guide element is advantageously made of a polymer, which is preferably a plastic that does not swell in the brake fluid.

This creates a very cost-effective guide element that is also elastic and noise-insulating. Polyetheretherketone (PEEK), polyphenylene sulfide (PPS) and/or polyketone (PK) are used as preferred polymers or materials. PEEK and PPS are both high-temperature resistant thermoplastics with particularly high chemical resistance to hydrocarbons. The use of PEEK, which is very wear-resistant and has a low coefficient of friction, is particularly preferred. PEEK has therefore proven to be a very good substitute for a metal that would otherwise be used. PPS exhibits particularly high mechanical strength. PK is moreover particularly elastically deformable.

According to an example embodiment of the present invention, the guide element advantageously comprises a separation ridge, which is accommodated in the groove. The guide element is preferably made of a polymer with an injection molding process using two molded parts, which are disposed during the manufacturing process in such a way that the separation ridge created by the injection molding process does not affect the radial inner surface on the finished guide element. The separation ridge is preferably located radially on the outside and is accommodated in the groove in the assembled state of the guide element. The guidance of the piston is therefore not disturbed.

In an associated manufacturing process of the guide element, according to an example embodiment of the present invention, a mold separation of a first and second molded part is realized preferably axially on the inner end face and/or axially on the outer end face of the guide element in a manner suitable for function and production. The first molded part is used to create both a radially outer abutment of the guide element on the piston seat and a radially inner abutment on the piston, and thus the guidance of the piston, in a single mold half. This produces corresponding guidance and abutment regions on the guide element with the radial inner surface and the radial outer surface without any separation ridge. A separation ridge that forms during the manufacturing process occurs on the guide element at the mold separation of the two molded parts and is preferably accommodated in the groove in the brake actuating device.

According to an example embodiment of the present invention, for this purpose, a first molded part is preferably provided in the manufacturing process, which is designed as a cylinder with a base region that projects radially from the cylinder and a first wall region that projects axially radially outward from the base region, extends along the cylinder and has a hollow cylindrical radial spacing from the cylinder. A second molded part is provided, which is designed as a hollow cylinder that radially surrounds the cylinder with a second wall region that extends along the first wall region and an overhang that is directed radially inward from the second wall region. Joining the two molded parts together in axial direction creates a tool for injection molding. The overhang rests radially against the cylinder. The second wall region furthermore rests radially against the first wall region, which preferably creates an axial spacing between the overhang and the first wall region. The axial spacing leads to the radial elevation of the guide element. A separating element, with which the radial and the axial spacing is interrupted in radial direction in a limited region, is moreover preferably disposed radially between the cylinder and the first wall region as well as the second wall region. The separating element is designed such that it projects axially from the cylinder. This leads to an axial opening of the guide element. After liquefied material is injected into the tool and the material is allowed to solidify, the two molded parts are axially removed from one another again.

According to an example embodiment of the present invention, on its groove cheek that faces the end region or is on the rod side, the groove also advantageously comprises a chamfer, which is designed such that it widens in the direction of an interior space of the piston seat. The rod-side groove cheek is thus beveled on its edge facing the piston seat in such a way that insertion of the guide element from the mouth into the interior space is made easier. The groove preferably otherwise has a rectangular cross-section in longitudinal section.

The present invention is furthermore directed to a method for producing the described brake actuating device. According to an example embodiment of the present invention, the production method comprises the steps: providing a block-shaped housing, machining a piston seat in the provided housing, machining a groove in a guide section of the piston seat for receiving a guide element, inserting at least a portion of the guide element into the groove under radial pretension and inserting a piston into the piston seat radially inside the guide element. The guide element is thus already held axially in the groove before the piston is assembled. This enables simple and cost-efficient production that eliminates the need for caulking that would otherwise be required. The piston is preferably inserted into the piston seat after the guide element.

According to an example embodiment of the present invention, when machining the groove for the guide element, at least one seal receiving groove is further advantageously machined in the piston seat at the same time. The radial and axial support for the guide element and for the additionally required at least one sealing element in the guide section are thus created in one step, saving time and money. A chamfer that widens into the piston seat is preferably machined at the same time on the at least one seal receiving groove and on the groove for the guide element on a respective rod-side groove cheek.

For insertion of the guide element into the piston seat, a conical mounting sleeve which tapers in the direction of the piston seat is preferably placed on the mouth. The guide element is inserted into the mounting sleeve and pushed through the mounting sleeve and into the piston seat under radial pretension. The guide element snaps at least partly, in particular with its radial elevation, into the groove of the guide section.

The guide element is preferably brought into radial pretension as it is being pushed through the mounting sleeve. For this purpose, the two ring ends are preferably partly overlaid at the advantageous opening of the guide element. The lateral surface is in particular twisted in at its opening. Ring ends or ends of the lateral surface located at the opening slide off axially when being twisted in, as a result of which the guide element tapers in its ring shape. Shrinking is achieved. When the guide element is pushed further through the mounting sleeve, the guide element, which is under radial pretension, snaps open into its ring shape when it reaches the guide section with its groove. A preferred symmetrical guide element without a radial elevation snaps into the groove along its entire axial extent.

Particularly preferably, a guide element with an external radial elevation that snaps into the groove of the piston seat is used.

Radial abutment of the radial outer surface in the guide section occurs due to the pretension of the guide element.

The present invention is also directed to use of such a brake actuating device in a vehicle brake system. According to an example embodiment of the present invention, with the brake actuating device, the mentioned guide element in the mentioned groove is used wherever transverse forces act on a piston coupled to it, in particular via a pedal. The actuating device is preferably used in a master brake cylinder of a vehicle brake system. The guide element serves to guide an associated piston, in particular a primary piston of the master brake cylinder, which is preferably designed as a tandem master brake cylinder. The brake actuating device is particularly preferably used in a power brake system with actuation by means of external power, such as in so-called power brakes. Use in a brake booster or in servo brakes is also preferred.

Embodiment examples of the present invention are explained in more detail in the following with reference to the figures.

### DETAILED DESCRIPTION OF EXAMPLE EMBODIMENTS

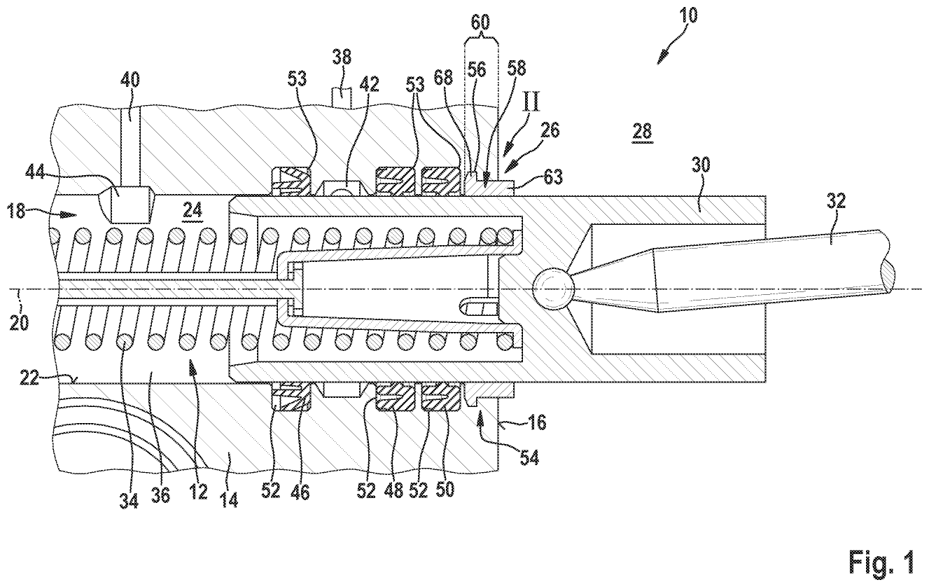

FIG. 1 shows a partial longitudinal section of a first embodiment example of a brake actuating device according to the present invention.

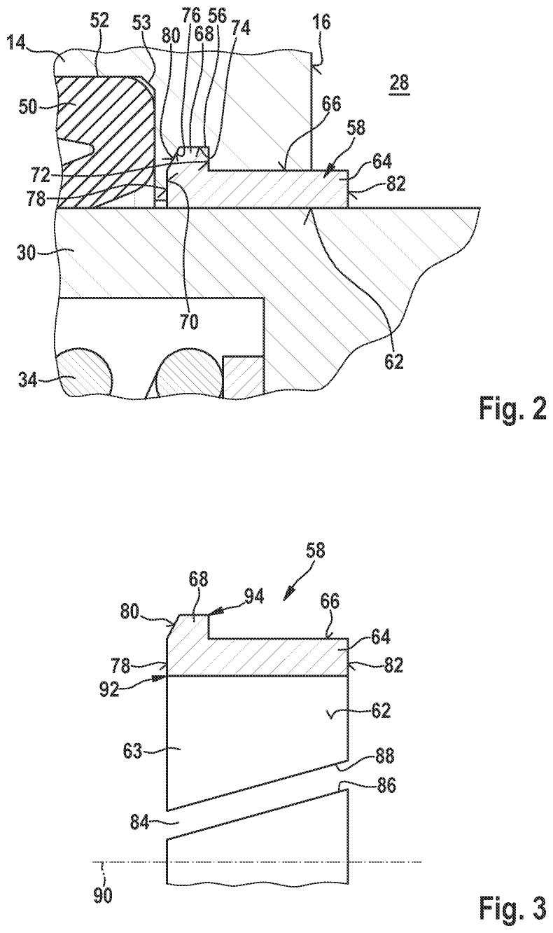

FIG. 2 shows the detail II in FIG. 1.

FIG. 3 shows a longitudinal section of a guide element of the first embodiment example in an unassembled state.

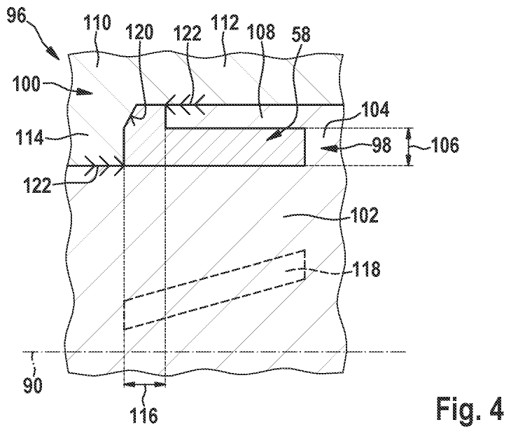

FIG. 4 shows a schematic illustration of a tool for producing the guide element according to FIG. 3, according to an example embodiment of the present invention.

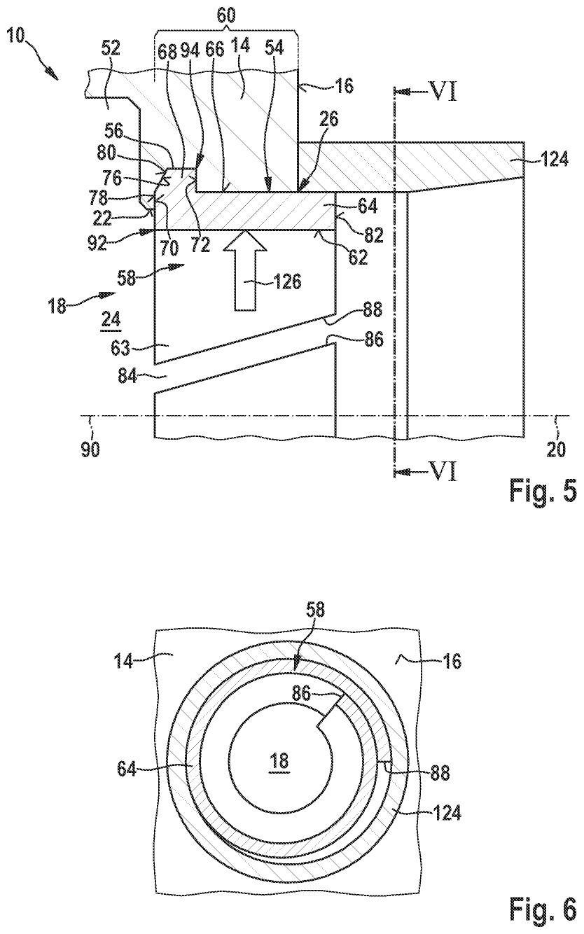

FIG. 5 shows a longitudinal section of an assembly of the guide element according to FIG. 3 in the first embodiment example.

FIG. 6 shows a reduced section VI-VI according to FIG. 5 prior to insertion of the guide element according to FIG. 3.

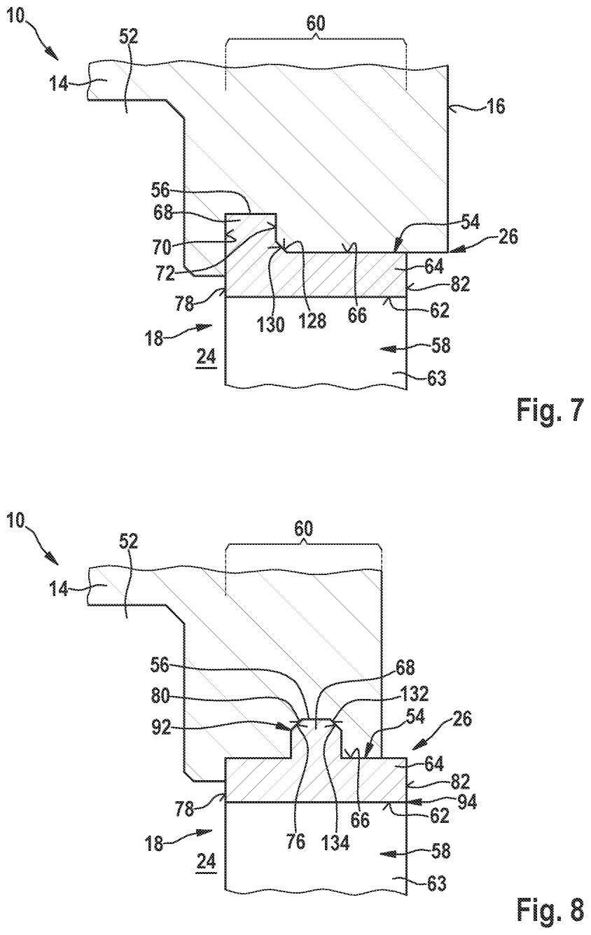

FIG. 7 shows a partial longitudinal section of a second embodiment example of a brake actuating device according to the present invention.

FIG. 8 shows the view according to FIG. 7 of a third embodiment example of the present invention.

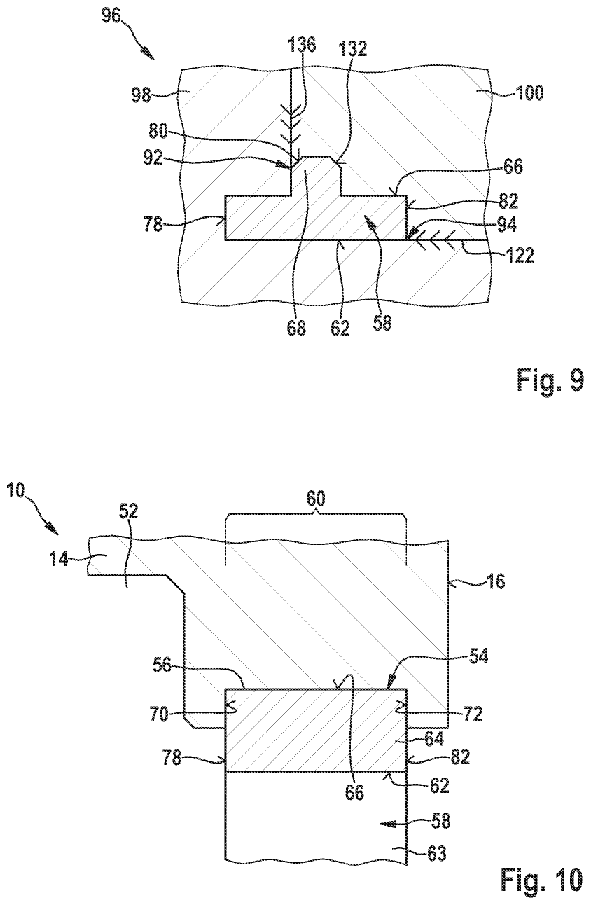

FIG. 9 shows a schematic illustration of a tool for producing a guide element according to FIG. 8, according to an example embodiment of the present invention.

FIG. 10 shows the view according to FIG. 7 of a fourth embodiment example of the present invention.

### DETAILED DESCRIPTION OF EXAMPLE EMBODIMENTS

FIGS. 1 and 2 show a section of a brake actuating device 10 of a master brake cylinder 12 of a hydraulic vehicle brake system, which is not shown in further detail, as used in brake systems with slip controls such as ABS and ESP. The brake actuating device 10 is integrated in an indicated cuboid hydraulic block or block-shaped housing 14 made of aluminum.

The master brake cylinder 12 is disposed in a piston seat 18 provided perpendicular to a narrow side 16 of the housing 14.

The piston seat 18 is cylindrical and designed as a stepped bore and is radially surrounded along its receiving axis 20 by a wall 22 with which an interior space 24 is formed. On the narrow side 16, the interior space 24 or the piston seat 18 comprises a mouth 26 to the housing exterior 28, through which the piston 30 projects into the piston seat 18.

The piston 30 comprises a piston axis that is congruent with the receiving axis 20 and is connected in an articulated manner to an input rod or piston rod 32 outside the housing 14. The piston rod 32 is coupled to a not depicted brake pedal or pedal that can be actuated by a user of the vehicle. When the pedal is actuated, the piston 30 is mechanically displaced along the receiving axis 20 in the piston seat 18 by means of the piston rod 32. The piston 30 is a so-called primary piston, which is supported by a compression spring 34 on a further piston, not shown here, disposed axially downstream of the piston 30. The further piston is a secondary piston and is likewise axially displaceable. This creates two axially successively disposed brake cylinders of a master brake cylinder 12 designed as a tandem master brake cylinder for actuating a dual-circuit brake system.

For this purpose, there is a pressure chamber 36 between the piston 30 and the not-depicted further piston and the wall 22. The pressure chamber 38 is connected to a reservoir line 38, through which pressure medium can be drawn from a not-depicted reservoir into the pressure chamber 36 when the piston 30 moves out of the piston seat 18. From the pressure chamber 36, the pressure medium can be pumped through a brake line 40 into a first brake circuit, which is achieved when the piston 30 pushes into the piston seat 18.

Axially between an inlet 42 from the reservoir line 38 and an outlet 44 into the brake line 40, the piston 30 is surrounded by a radially surrounding pressure seal 46. The piston 30 is also surrounded axially between the inlet 42 and the mouth 26 by two radially surrounding separating seals 48, 50. The seals 46, 48 and 50 are disposed in an associated ring-shaped sealing groove 52 in the wall 22 and extend slightly radially into the piston seat 18. Each seal receiving groove or sealing groove 52 comprises a chamfer 53 on the rod side that widens into the piston seat 18.

A further groove 56 is additionally formed in the wall 22 in an end region 54 of the piston seat 18 which faces the mouth 26. The groove 56 is axially disposed between the sealing groove 52 associated with the axially outer separating seal 50 and the mouth 26. The groove 56 is a guide groove, in which a guide element 58 that radially surrounds the piston 30 is accommodated. The end region 54 thus forms a guide section 60 of the piston seat 18, in which the guide element 58 serves to receive axial and transverse forces that occur during operation.

For this purpose, the guide element 58 is partly accommodated in the groove 56 and partly projects radially into the piston seat 18. A radial inner surface 62 of the guide element 58, which is designed as a guide ring 63 or guide bushing with a casing 64, is located there and rests against the piston 30. The casing 64 extends axially along the receiving axis 20 and projects out of the mouth 26 beyond the housing 14. The casing 64 further comprises a radial outer surface 66 opposite to the radial inner surface 62 with which the guide element 58 rests against the wall 22.

A radial elevation 68 which radially surrounds the outer surface 66 is formed on the radial outer surface 66, by means of which the guide element 58 is accommodated in the groove 56. In combination with the groove 56 and the radial elevation 68, the guide element 58 is held axially in position. This eliminates the need for conventional caulking between the guide element 58 and the housing 14.

In detail, the groove 56 is radially circumferential and comprises two radial groove cheeks 70, 72 with a groove base 74 in between. The axially inner groove cheek 70 is designed with a bevel 76 which extends axially outward in the direction of the groove base 74. Correspondingly counter-shaped, the radial elevation 68 comprises a chamfer 80 which tapers in the direction of an inner end face 78 of the guide element 58 and rests against the bevel 76. The outer end face 82 of the guide element 58 is opposite to its inner end face 78.

During an axial movement of the piston 30 and a radial movement of the piston 30 caused by the piston rod 32, axial forces are received by a form fit created by means of the groove 56 and the guide element 58 and radial forces are passed on to the piston seat 18 and the housing 14. The guide element 58 moreover extends to outside the housing 14, as a result of which an effective guide region is extended beyond the guide section 60.

FIG. 3 shows the guide element 58 in an unassembled state. It can be seen that the guide element 58 comprises a continuous slot-shaped opening 84 from the outer end face 82 to the inner end face 78 and from the radial outer surface 66 to the radial inner surface 62. The guide element 58 is thus designed as a radially open guide ring 63 comprising two oppositely disposed ring ends 86, 88. The ring ends 86, 88 extend parallel to one another and obliquely to a longitudinal axis 90 of the guide element 58. The opening 84 extends obliquely to the longitudinal axis 90. In other not-depicted embodiment examples, the opening 84 is Z-shaped, V-shaped, W-shaped or helical along the longitudinal axis 90.

On the radially inner side of its inner end face 78, the guide element 58 further comprises an axial separation ridge 92 which was formed during a manufacturing process of the guide element 58. Another such axial separation ridge 94 is located diagonally opposite on the radial elevation 68, radially on the outside and facing the outer end face 82. In the assembled state of the guide element 58, the thus configured separation ridge 94 is accommodated in the groove 56. Also, none of the separation ridges 92, 94 are located on the radial inner surface 62, as a result of which guidance of the piston 30 is not undesirably influenced.

FIG. 4 shows a tool 96, with which the guide element 58 comprising such a smooth radial inner surface 62 is produced using an injection molding process. The tool 96 includes a first molded part 98 and a second molded part 100. The first molded part 98 is designed such that it can be used to form the radial outer surface 66 without the radial elevation 68 as well as the radial inner surface 62 and the outer end face 82. Thus, a radially inner abutment region on the piston 30 can be created with the radial inner surface 62 and a radially outer abutment region on the wall 22 can be created with the radial outer surface 66 using the first molded part 98 as a single mold half. The second molded part 100 can be used to form the radial elevation 68 and the inner end face 78.

In detail, the first molded part 98 comprises a cylinder 102 as a core, on which a ring or base region 104 projects radially. A first wall region 108 extends from the base region 104 along the cylinder 102 at a hollow cylindrical radial spacing 106 from the cylinder 102.

A second molded part 100 is designed as a hollow cylinder 110 that radially surrounds the cylinder 102 with a second wall region 112 that extends along the first wall region 108 and an overhang 114 that is directed radially inward from the second wall region 112. In the shown joined state of the two molded parts 98, 100, the overhang 114 has an axial spacing 116 from the first molded part 98. Radially, the overhang 114 rests against the cylinder 102 of the first molded part 98. The second wall region 112 furthermore rests against the first wall region 108. The radial elevation 68 can be formed with the axial spacing 116.

A narrow separating element 118 which is designed in one piece and extends obliquely to the longitudinal axis 90 is disposed radially between the first wall region 108 and the cylinder 102. The separating element 118 is shown purely schematically with dash-dotted lines. The separating element 118 cuts through the radial spacing 106 from the cylinder 102 to the first wall region 108 and the axial spacing 116 from the cylinder 102 to the second wall region 112. The opening 84 can thus be formed by means of the separating element 118.

The overhang 114 also comprises a circumferential bevel 120 radially on the outside, which extends from the overhang 114 in the direction of the first wall region 108 of the first molded part 98. The radially circumferential chamfer 80 of the guide element 58 can thus be formed.

In the injection molding process, the two molded parts 98, 100 are arranged to form the tool 96 by joining them together in axial direction as described. A liquefied plastic material, such as PEEK, is then injected into the tool 96. After cooling and solidification, the tool 96 is opened by removing the two molded parts 98, 100 in axial direction from one another at two axial separation planes 122 (each shown with 3 arrows). This creates the two axial separation ridges 92, 94.

FIG. 5 shows a longitudinal section of an assembly of the guide element 58 produced by means of the tool 96 in the state in which it is already inserted into the guide section 60 and the groove 56. For assembly, a conical mounting sleeve 124 is placed on the piston seat 18 at the mouth 26. The guide element 58 is inserted into the mounting sleeve 124 with its inner end face 78 and the chamfer 80 facing in the direction of the piston seat 18 and pushed through the mounting sleeve 124. The guide element 58 shrinks or rotates in such a way that the two ring ends 86, 88 slide axially obliquely over one another via the slotted, oblique opening 84, which causes the ring shape of the guide element 58 to taper. This creates a radial pretension 126 of the guide element 58. When it reaches the guide section 60, the guide element 58 snaps open into its ring shape and the radial elevation 68 is forced into the groove 56. As a result of the radial pretension 126, the guide element 58 rests radially against the wall 22. This creates an axial form fit by means of the radial elevation 68 in the groove 56. The opening 84 simplifies assembly. In the assembled state, this compensates possible tolerances.

The piston 30 and the seals 46, 48, 50 are moreover assembled before or after the guide element 58. The seals 46, 48, 50 are preferably assembled before and the piston 30 after the guide element 58.

FIG. 6 shows a cross-section of the mounting sleeve 124 and the twisted-in guide element 58 with overlaid ring ends 86, 88 in an assembly state just prior to insertion into the piston seat 18.

FIG. 7 shows a brake actuating device 10 comprising the guide element 58 in which the slotted opening 84 is not shown. In contrast to the brake actuating device 10 according to FIG. 1, the guide element 58 is not chamfered on its inner end face 78. A chamfer 128 is instead provided on the radial elevation 68 in the direction of the outer end face 82. The chamfer 128 rests against a chamfer 130 of the groove 56, which is designed such that it widens at the groove cheek 72 facing the end region 54 in the direction of the interior space 24. The guide element 58 can thus slide particularly easily on the chamfer 130 into the groove 56 during assembly. The guide element 58 with its casing 64 is furthermore accommodated completely in the end region 54 of the piston seat 18 and protected from external effects. In the guide element 58 according to FIG. 1 and the guide element 58 according to FIG. 7, the elevation 68 is respectively disposed axially off-centered on the outer surface 66. In both cases, therefore, the guide element 58 is asymmetrical in relation to its longitudinal axis 90 or the receiving axis 20.

In the guide element 58 of the brake actuating device 10 shown in FIG. 8, on the other hand, the radial elevation 68 is disposed axially in the center of the outer surface 66. The elevation 68 comprises the chamfer 80, which tapers in the direction of the inner end face 78, radially on the outside. A chamfer 132 which tapers in the direction of the outer end face 82 is provided as well. Both chamfers 80, 132 rest against counter-shaped bevels 76 and 134 of the groove 56. The guide element 58 is thus symmetrical in relation to the longitudinal axis 90. The guide element 58 furthermore projects beyond the housing 14, as a result of which its guide region is extended.

FIG. 9 highly schematically shows the tool 96, which is adapted for a manufacturing process of the guide element 58 according to FIG. 8 such that the separation ridges 92, 94 of this guide element 58 also do not influence the guidance of the piston 30. For this purpose, the two molded parts 98, 100 are designed such that they are correspondingly stepped, so that a radial separation plane 136 extends on the chamfer 80 and an axial separation plane 122 on the radially inner outer end face 82.

In the brake actuating device 10 shown in FIG. 10, the guide element 58 has no a radial elevation 68 and is symmetrical. The guide element 58 is accommodated in the groove 56 with its entire axial extent. The two groove cheeks 70, 72 each form an abutment shoulder within the housing 14, as a result of which the guide element 58 is axially held in position.

What is claimed is:

1. A brake actuating device of a vehicle brake system, comprising:
a housing, in which a piston seat is disposed, the piston seat being surrounded by a wall and including a receiving axis along which a piston to be coupled to a piston rod can be accommodated in the piston seat in an axially displaceable manner, wherein, at an end region of the piston seat which is directed toward the piston rod, the piston seat includes a guide section in which a guide element for guiding the piston rests radially against the wall, wherein the guide element is axially held in position by a radial groove disposed in the guide section.

2. The brake actuating device according to claim 1, wherein, at least for insertion into the guide section, the guide element includes a radially directed pretension with which the guide element is forced into the groove.

3. The brake actuating device according to claim 1, wherein the guide element is a radially open guide ring including an opening and two oppositely disposed ring ends, wherein, at least for insertion into the guide section, the two ring ends are at least partly overlaid at the opening.

4. The brake actuating device according to claim 1, wherein the guide element includes a radial outer surface with a radial elevation, wherein the radial elevation is configured to engage in the groove.

5. The brake actuating device according to claim 4, wherein the radial elevation includes a chamfer which is tapered.

6. The brake actuating device according to claim 4, wherein the radial elevation is disposed axially in a center of the radial outer surface.

7. The brake actuating device according to claim 4, wherein the radial elevation is disposed axially off-centered on the radial outer surface.

8. The brake actuating device according to claim 1, wherein the guide element includes a separation ridge which is accommodated in the groove.

9. The brake actuating device according to claim 1, wherein, characterized in that, on its groove cheek facing the end region, the groove includes a chamfer which is configured such that it widens in a direction of an interior space of the piston seat.

10. A method for producing a brake actuating device, comprising the following steps:
providing a block-shaped housing;
machining a piston seat in the provided housing;
machining a groove in a guide section of the piston seat for receiving a guide element;
inserting at least a portion of the guide element into the groove under radial pretension; and
inserting a piston into the piston seat radially inside the guide element.
